(19) United States
(12) Patent Application Publication
(10) Pub. No.: US 2006/0170533 A1
(43) Pub. Date: Aug. 3, 2006

(54) Method and system for controlling networked wireless locks

(75) Inventors: Alfred Chioiu, South San Francisco, CA (US); Anish Srivastava, South San Francisco, CA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: FRANCE TELECOM, Paris (FR)

(21) Appl. No.: 11/048,795

(22) Filed: Feb. 3, 2005

(51) Int. Cl. H04B 1/00; G05B 19/00

(52) U.S. Cl. 340/5.61; 455/418

(57) ABSTRACT

A system including a mobile device; a lock device having a lock identification, and configured to communicate wirelessly with the mobile device; and a server having access to a database wherein (a) a key is associated with said lock identification and (b) said lock identification is associated with at least one authorized user of said lock device, the server is configured to receive from the mobile device said lock identification and a user identification and to transmit the key associated with the lock identification when the user identification corresponds to an authorized user associated with said lock identification.

### BACKGROUND OF THE INVENTION

1. Field of the Invention

The present invention is directed to a method and system for controlling networked wireless locks using a mobile device, and, in one embodiment, to a method and system for using a cell phone to obtain a key from a computer network and to communicate with a lock using a short range radio link in order to unlock the lock using the key.

2. Discussion of the Background

Many types of locks are in use today including (a) traditional lock and key combinations, (b) keyless number pad locks, and (c) locks opened using electronic badges, fobs, or the like. Each of these types of locks has limitations

For instance, traditional lock and key combinations require possession of the key to open the lock even in the circumstance where only temporary access is required to the thing locked. For example, if a landlord wants to provide a potential tenant temporary access to a property, then the landlord has to either entrust the key to the potential tenant or be physically present to open the lock. Likewise, keyless number pad locks require knowledge of an access number—even for temporary access.

Lost or misplaced electronic badges (fobs) require implementation of various inconvenient solutions including issuing a temporary badge. Similarly, if a key to a home lock is lost, then resort to a spare key stored offsite is typically required. Lastly, electronic badges present various issues regarding distributing badges that require the physical presence of the employee.

Many locks today can be opened using some form of wireless remote technology. However, none of the currently employed locks have network connectivity functionality via mobile devices. Such functionality would allow for management and deployment of networked wireless locks (NWL) in many environments.

### SUMMARY OF THE INVENTION

The present invention is directed to networked wireless lock controlled by a mobile device using, but not limited to, a short range wireless technology such as Zigbee™, Bluetooth™, or active radio frequency identification (“RFID”) tags, among others.

In one embodiment, the mobile device is configured to communicate with a stand-alone lock using a key retrieved from a local server.

In another embodiment, the mobile device is configured to communicate with a networked lock and a local server. The local server is networked with the lock. Hence, the mobile device obtains the ID of the lock and provides the ID to the local server and the local server communicates via the network (directly) with the lock.

In another embodiment, the mobile device is configured to send an unlock command to an application server via a gateway. The unlock message gets relayed to a remote server residing on a local area network (“LAN”) connected to the lock. The remote server verifies the user ID of the mobile device and the lock is controlled.

A management interface program can run directly on a server, on a remote computer, or on a mobile device. The management interface enables the host to have the following functionality: (a) adding/deleting new users to the system and (b) modifying user lock access permissions. The management interface can also be used to access logs (databases) and automate diagnostics and maintenance activities.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic illustration of a lock, mobile device, and server configured according to an embodiment of the present invention;

FIG. 2 is a schematic illustration of a lock, mobile device, and server configured according to a second embodiment of the present invention;

FIG. 3 is a schematic illustration of a lock, mobile device, and server configured according to a third embodiment of the present invention;

FIG. 4 is a schematic illustration of a lock, mobile device, and first and second servers configured according to a fourth embodiment of the present invention;

FIG. 5 is a schematic illustration of the process for running a management interface program of a networked wireless lock directly on a server, on a remote computer, or on a mobile device according to an embodiment of the present invention; and

FIG. 6 is a schematic illustration of a computer for implementing at least a portion of the present invention.

### DETAILED DESCRIPTION OF THE PREFERRED EMBODIMENTS

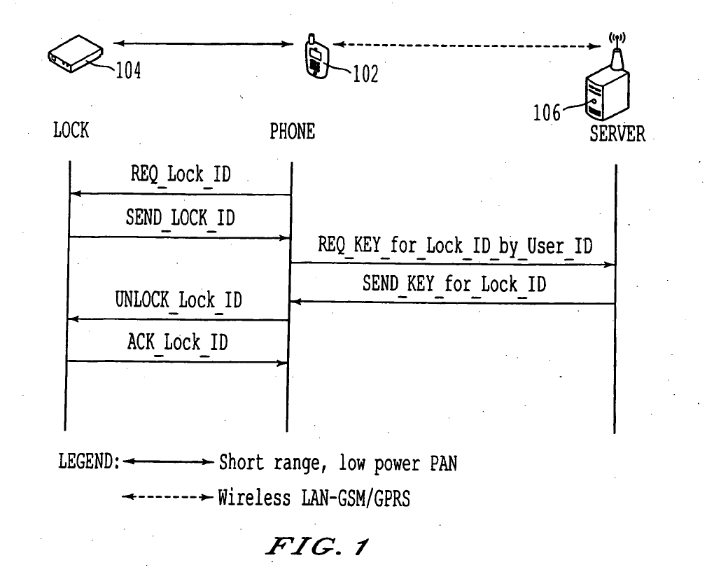

Referring now to the drawings, wherein like reference numerals designate identical or corresponding parts throughout the several views, FIG. 1 is a schematic illustration of a lock, mobile device, and server configured according to an embodiment of the present invention. In FIG. 1 a mobile device 102 is configured to communicate with a wireless lock 104 using a short range, low power radio link such as Bluetooth™, 802.15.4/Zigbee™, proprietary ISM, or the like. The mobile device 102 could be in the form of a laptop, a personal digital assistant (“PDA”), cell phone, satellite phone, smart phone, or two-way pager. The mobile device manages at least one key and is able to control the wireless lock 104.

The wireless lock 104 according to one embodiment of the invention is configured for bi-directional communication with the mobile device 102 using a low power radio link. In another embodiment, the wireless lock only requires wireless reception functionality relative to the mobile device 102 as it is connected to a computer network which provides control. The wireless lock 104 has a LockID which according to one embodiment of the invention can be modified.

As shown in FIG. 1, the mobile device 102 obtains the LockID from wireless lock 104 using the low power radio link. Upon obtaining the LockID, the mobile device 102 makes a key request to a local server 106. The mobile device 102 can communicate with the local server for example via a Global System for Mobile Communications/General Packet Radio Service (GSM/GPRS) enabled network or any wireless communication system which enables packet-based communication between a mobile device and a server.

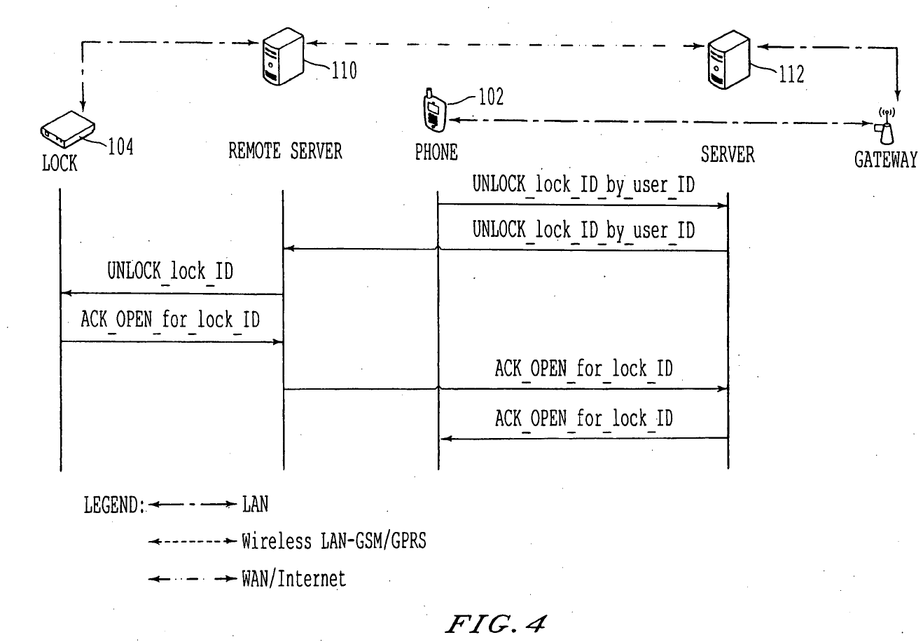

In one embodiment of the invention, the local server 106 securely stores a key to at least one wireless lock including wireless lock 104. Further, the local server 106 is configured to distribute keys in view of dynamically configurable rules/controls and maintain a log of transactions (e.g., the time the key was granted and to whom the key was granted). A client-server architecture can be employed where a server manages access to multiple locks. As illustrated in FIG. 4, the server can be remote as opposed to local.

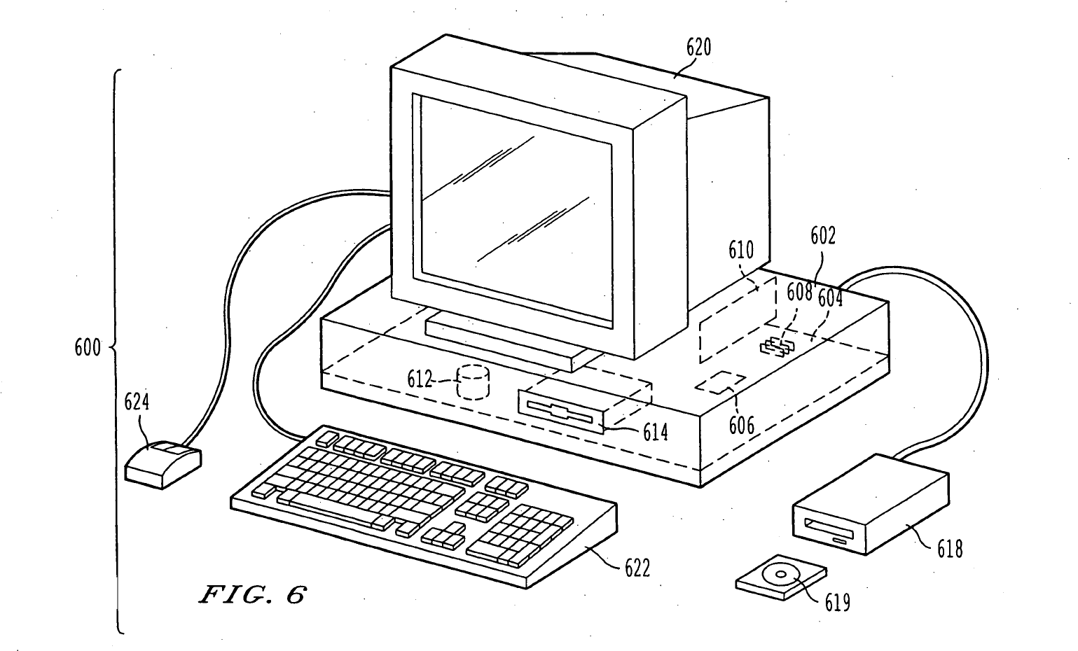

Whether the server is local or remote, the server is a computer. As illustrated in FIG. 6, the computer 600 has a housing 602 which a motherboard 604 which contains a CPU 606, memory 608 (e.g., DRAM, ROM, EPROM, EEPROM, SRAM, SDRAM, and Flash RAM), and other optional special purpose logic devices (e.g., ASICs) or configurable logic devices (e.g., GAL and reprogrammable FPGA). The computer 600 also includes plural input devices, (e.g., a keyboard 622 and mouse 624), and a display card 610 for controlling monitor 620. In addition, the computer system 600 further includes a floppy disk drive 614; other removable media devices (e.g., compact disc 619, tape, and removable magneto-optical media (not shown)); and a hard disk 612, or other fixed, high density media drives, connected using an appropriate device bus (e.g., a SCSI bus, an Enhanced IDE bus, or a Ultra DMA bus). Also connected to the same device bus or another device bus, the computer 600 may additionally include a compact disc reader 618, a compact disc reader/writer unit (not shown) or a compact disc jukebox (not shown). Although compact disc 619 is shown in a CD caddy, the compact disc 619 can be inserted directly into CD-ROM drives which do not require caddies. In addition, a printer (not shown) also provides printed listings related to the management interface of the invention.

As stated above, the system includes at least one computer readable medium. Examples of computer readable media are compact discs 619, hard disks 612, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling both the hardware of the computer 600 and for enabling the computer 600 to interact with a human user. Such software may include, but is not limited to, device drivers, operating systems and user applications, such as development tools. Together, the computer readable media and the software thereon form a computer program product of the present invention for managing wireless locks and their associated keys. The computer code devices of the present invention can be any interpreted or executable code mechanism, including but not limited to scripts, interpreters, dynamic link libraries, Java classes, and complete executable programs. Moreover, the computer code devices of the present invention need not be co-resident and may instead be physically separate and communicate with each other. Such communications may be via either physically linked communication (e.g., over serial or USB connections) or may be via indirect communications (e.g., using packet-based communications where addressing is used to identify the destination (and potentially source) of the communication). Examples of packet based communications include TCP/IP, UDP/IP, and Reliable Datagram Protocol (RDP). Such communications may be over any communications adapter, including, but not limited to, Ethernet, Token-ring, ATM, and FDDI.

As would be appreciated by one of ordinary skill in the art, the present invention need not be implemented on a general purpose computer, but may instead be implemented on any hand-held or fixed (e.g., desktop) device. Examples of such devices include PDAs, mobile and/or smart phones.

Again referring to FIG. 1, in response to the key request, the local server 106 replies back to the mobile device 106 with the wireless lock's associated key if the controls/rules associated with the wireless lock 104 have been satisfied. In the event that the associated rules/controls are not satisfied, then the local server 106 denies the key request and the unlock operation fails.

If the mobile device 102 successfully obtains the key associated with the wireless lock 104, UNLOCK_Lock_ID, then the mobile device is able to unlock the wireless lock 104 when the mobile device is in communication range. The UNLOCK_Lock_ID is sent to the mobile device 102 from the local server 106 in encrypted format. According to one embodiment, the wireless lock 104 has reduced capabilities relative to the server in terms of memory and computing power. However, devices of this nature typically do not have any operating system, and are highly integrated devices in which functions such as protocol stacks and encryption capabilities are implemented in hardware. Regarding wireless lock 104, the UNLOCK_Lock_ID command would be encrypted using a form of encryption such as AES. The encryption would be implemented at the application level in order that it could be completed on at least one of the server 106 and the wireless device 102.

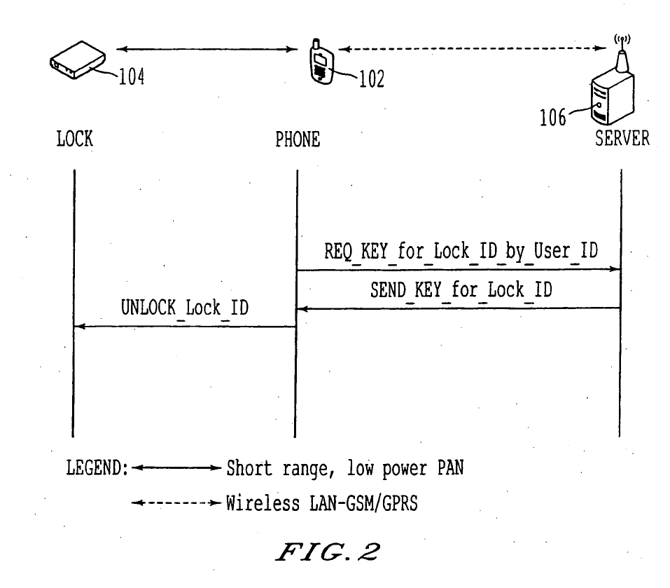

FIG. 2 illustrates another embodiment of the invention illustrated in FIG. 1. The system illustrated in FIG. 2 includes a wireless lock 104 which is configured for unidirectional communication. In this instance, the wireless lock 104 is configured to receive the UNLOCK_Lock_ID command from the mobile device 102, but is not configured to transmit the Lock_ID to the mobile device 102. Rather, the mobile device 102 must either have stored in its memory the Lock_ID of the wireless lock 104 or the user of the mobile device 102 must manually obtain the Lock_ID for the wireless lock 104. Upon obtaining the Lock_ID, the embodiment of the invention illustrated in FIG. 2 functions in the same manner as the embodiment illustrated in FIG. 1.

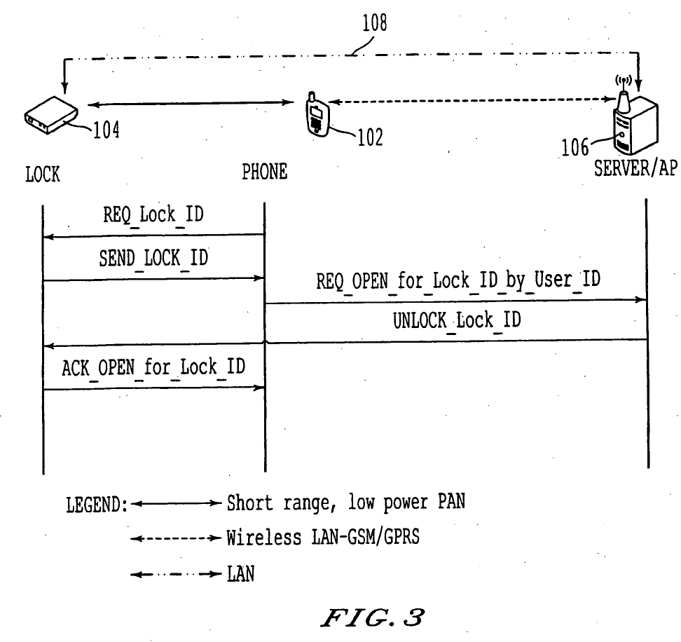

FIG. 3 illustrates another embodiment of the invention illustrated in FIG. 1. The system illustrated in FIG. 3 includes a wireless lock 104 which is configured for bi-directional communication as described with regard to FIG. 1. However, as illustrated in FIG. 3, if the request by the mobile device 102 is granted by local server 106, then the local server 106 sends the encrypted key directly to the wireless lock 104 via a local area network (“LAN”) 108.

FIG. 4 illustrates an embodiment of the invention utilizing a remote server 110 as opposed to a local server enabling a user of the mobile device 102 to communicate with the wireless lock 104 even when the mobile device is not located near the lock. The mobile device 102 is configured to send an unlock command to an application server 112 via a gateway to the Internet. The unlock command includes a user identification (“userID”). The unlock command is relayed from the application server to a remote server 110 residing on the LAN where the wireless lock 104 is connected to. The remote server 110 verifies the userID and the wireless lock 104 is subsequently unlocked. An acknowledgment that the lock has been opened is sent to the mobile device 102 via the remote server 110 and the application server 112.

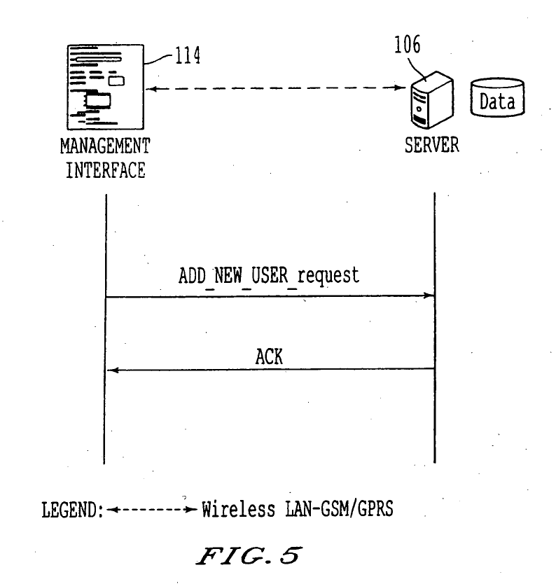

A management interface program can run directly on a local server, on a remote server, or on a mobile device. The management interface enables the host to have the following functionality: (a) adding/deleting new users to the system and (b) modifying user lock access permissions. The management interface can also be used to access logs (databases) and automate diagnostics and maintenance activities. FIG. 5 illustrates a message exchange for adding a new user.

Hence, the present invention enables control of a locking device using a radio interface, without reliance of the public switched telephone network. Further, keys are managed using a server which provides added flexibility and variability. Encryption renders the process and the system secure. Obviously, numerous modifications and variations of the present invention are possible in light of the above teachings. It is therefore to be understood that within the scope of the appended claims, the invention may be practiced otherwise than as specifically described herein.

1. A system comprising:
a mobile device;
a lock device having a lock identification, and configured to communicate wirelessly with the mobile device; and
a server having access to a database wherein (a) a key is associated with said lock identification and (b) said lock identification is associated with at least one authorized user of said lock device, the server is configured to receive from the mobile device said lock identification and a user identification and to transmit the key associated with the lock identification when the user identification corresponds to an authorized user associated with said lock identification.

2. The system of claim 1, wherein the lock device is configured for bi-directional communication with the mobile device.

3. The system of claim 1, wherein the lock device is configured to receive wireless communications from the mobile device and is connected to the server via a computer network in order to receive control commands.

4. The system of claim 1, wherein the server is configured to control access to the lock based on configurable rules.

5. The system of claim 1, wherein the server is configured to maintain a log of transactions regarding the lock device.

6. The system of claim 1, wherein the server is configured to control a plurality of lock devices.

7. The system of claim 1, wherein the server is remotely located relative to the lock device.

8. The system of claim 3, wherein the computer network is a local area network.

9. A computer implemented method comprising the steps of:
associating a key with a lock identification of a wireless lock device;
associating the lock identification with at least one authorized user of said wireless lock device,
receiving data identifying a user and the wireless lock device;
determining from the data whether the user is authorized to control the wireless lock device; and
transmitting the key associated with the lock identification when the user identification corresponds to an authorized user associated with said lock identification.

10. The computer implemented method of claim 9, wherein the transmitting step includes the step of communicating with the wireless lock device via a local area network.

11. The computer implemented method of claim 9, wherein the determining step includes the step of applying reconfigurable rules stored in a database.

12. The computer implemented method of claim 9, further comprising the step of maintaining a log of transactions regarding the lock device.

13. The computer implemented method of claim 9, further comprising the step of associating a second key with a lock identification of a second wireless lock.

14. The computer implemented method of claim 9, wherein the transmitting step includes the step of communicating remotely with the wireless lock device via a local area network.

15. A computer readable medium containing program instructions for executing on a computer, which when executed by the computer, cause the computer to perform the steps of
associating a key with a lock identification of a wireless lock device;
associating the lock identification with at least one authorized user of said wireless lock device,
receiving data identifying a user and the wireless lock device;
determining from the data whether the user is authorized to control the wireless lock device; and
transmitting the key associated with the lock identification when the user identification corresponds to an authorized user associated with said lock identification.

16. The computer readable medium of claim 15, wherein the transmitting step includes the step of communicating with the wireless lock device via a local area network.

17. The computer readable medium of claim 15, wherein the determining step includes the step of applying reconfigurable rules stored in a database.

18. The computer readable medium of claim 15, further comprising the step of maintaining a log of transactions regarding the lock device.

19. The computer readable medium of claim 15, further comprising the step of associating a second key with a lock identification of a second wireless lock.

20. The computer readable medium of claim 9, wherein the transmitting step includes the step of communicating remotely with the wireless lock device via a local area network.
